(19) United States
(12) Patent Application Publication
(10) Pub. No.: US 2023/0107163 A1
(43) Pub. Date: Apr. 6, 2023

(54) Systems and Methods for Gas-Liquid Contactors for Rapid Carbon Capture

(71) Applicants: California Institute of Technology, Pasadena, CA (US); The Regents of the University of California, Oakland, CA (US)

(72) Inventors: Chengxiang Xiang, San Marino, CA (US); Shane Ardo, Irvine, CA (US); Leanna Schulte, Irvine, CA (US); Harry A. Atwater, South Pasadena, CA (US); Zejie Chen, Irvine, CA (US); Anastasiya Bender, Irvine, CA (US); Ibadillah A. Digdaya, Whittier, CA (US)

(73) Assignees: California Institute of Technology, Pasadena, CA (US); The Regents of the University of California, Oakland, CA (US)

(21) Appl. No.: 17/933,828

(22) Filed: Sep. 20, 2022

Related U.S. Application Data
(60) Provisional application No. 63/246,244, filed on Sep. 20, 2021.

(51) Int. Cl. C02F 1/20; B01J 27/232; B01J 27/06; B01J 31/06; B01J 31/26; B01J 35/06; B01D 69/02; B01D 69/08; B01D 71/36; C02F 1/44; C02F 1/66

(52) U.S. Cl. CPC C02F 1/20; B01J 27/232; B01J 27/06; B01J 31/06; B01J 31/26; B01J 35/065; B01D 69/02; B01D 69/08; B01D 71/36; C02F 1/44; C02F 1/66; B01D 2325/10; C02F 2101/10

(57) ABSTRACT

Systems and methods of gas-liquid contactors for direct ocean capture and/or direct air capture are described.

### CROSS-REFERENCE TO RELATED APPLICATIONS

The current application claims the benefit of and priority under 35 U.S.C. § 119 (e) to U.S. Provisional Patent Application No. 63/246,244 entitled “Catalyzed Gas-Liquid Contactor for Carbon Capture” filed Sep. 20, 2021. The disclosure of U.S. Provisional Patent Application No. 63/246,244 is hereby incorporated by reference in its entirety for all purposes.

### STATEMENT OF FEDERAL SUPPORT

This invention was made with government support under Grant No. DE-AR0001407 awarded by the Department of Energy. The government has certain rights in the invention.

### FIELD OF THE INVENTION

The present invention generally relates to systems and methods for carbon capture; and more particularly to systems and methods for gas-liquid contactors for rapid carbon capture.

### BACKGROUND

Traditional carbon capture from point sources exists at mature scale and at a rate of about 20,000 ton CO₂/day from a single point source. CO₂ capture from point sources, such as power plants, oil refineries, cement factories, involves chemical adsorption and desorption in amine-based solutions via temperature or pressure swings. However, a closed carbon cycle may also require capture of decentralized emissions from transport, agriculture and small emitters, which are already responsible for approximately 40% of total CO₂ emission. These dilute sources will be more difficult to replace by non-emitting technologies compared to point sources.

Carbon capture strategies can include direct air capture and direct ocean capture. Direct air capture (DAC) seeks to capture CO₂ gas from the atmosphere using sorbent materials, commonly made of strongly alkaline solutions, amines, or metal-organic frameworks. The feasibility of DAC process can be achieved in two sequential loops. In the first loop, CO₂ can be captured from air using aqueous alkaline solutions. In the second loop the alkaline solutions can be regenerated by a series of chemical steps, followed by calcination and release of concentrated CO₂. A large DAC system may be capable of capturing about 1-ton carbon/day.

Direct ocean capture (DOC) may leverage the fact that the solvation equilibrium between gaseous and aqueous CO₂ results in atmospheric carbon being concentrated in the ocean. DOC technologies need to overcome the requirement that proton-transfer reactions have to occur in oceanwater to convert bicarbonate (HCO₃⁻) into either carbonate (CO₃²⁻) that can precipitate out, or dissolved CO₂ that can be pulled off as gas with a vacuum. The current scale for DOC is less than about 1 kg carbon/day.

### BRIEF SUMMARY OF THE INVENTION

Systems and methods in accordance with various embodiments of the invention for gas-liquid contactors for carbon capture are described.

An embodiment of the invention includes a method for direct ocean capture comprising adding an influent solution to a container comprising at least one inlet, at least one outlet, at least one gas-liquid contactor, and at least one pump; where the solution comprises at least one dissolved inorganic carbon species in a liquid phase; where the at least one dissolved inorganic carbon species is converted to gas phase CO2 when not dissolved in the solution; where the solution is in contact with a first surface of the at least one gas-liquid contactor; where the at least one gas-liquid contactor provides an interface for efficient species transport between the liquid phase from the at least one dissolved inorganic carbon species and to the gas phase CO₂; collecting a gas stream from the pump, where the pump connects to a second surface of the at least one gas-liquid contactor, where the gas stream comprises the gas phase of CO₂; and collecting the solution from the at least one outlet of the container; where the at least one gas-liquid contactor separates the gas phase and the liquid phase of the at least one dissolved inorganic carbon species; where the concentration of the at least one dissolved inorganic carbon in the collected solution is lower than in the added solution; and where the at least one gas-liquid contactor is modified with at least one molecule and the at least one molecule increases an interconversion rate of the at least one dissolved inorganic carbon species from the solution in the liquid phase to the gas phase CO₂.

In another embodiment, the influent solution is selected from the group consisting of oceanwater, river water, lake water, desalinated water, an oceanwater mimic solution, and a synthetic oceanwater.

In an additional embodiment, the influent solution is titrated to a pH that is lower than the native pH of the influent solution.

In a further embodiment, the at least one gas-liquid contactor comprises a material selected from the group consisting of polydimethylsiloxane, polypropylene, polyvinylidene fluoride, polytetrafluoroethylene, an anion exchange membrane, and a cation exchange membrane.

In a further yet embodiment, the liquid phase of the at least one dissolved inorganic carbon species is selected from the group consisting of bicarbonate, carbonate, carbonic acid, aqueous carbon dioxide, and any combinations thereof.

In yet another embodiment, the at least one molecule increases an interconversion rate of bicarbonate dehydration and formation.

In another further embodiment, the solution collected from the at least one liquid outlet has a pH value higher than the solution added to the container.

In another yet embodiment, the at least one molecule is selected from the group consisting of a buffering molecule, a decorated mixed metal oxide, an inorganic coordination compound that mimics a carbonic anhydrase enzyme, a zinc-cyclen, polymer, an amine-based polymer, polyethyleneimine, a photoacid, an excited-state reversible photoacid, a non-reversible photoacid, a metastable photoacid, a photobase, an excited-state reversible photobase, a non-reversible photobase, a metastable photobase, and any combinations thereof.

In a further embodiment again, the photoacid comprises a trisodium salt of 8-hydroxypyrene-1,3,6-trisulfonate.

In yet another embodiment, the at least one molecule is on the first surface of the at least one gas-liquid contactor.

An additional further embodiment comprising acidifying the solution before extracting CO₂ from it.

In a further yet embodiment, a lower flow rate of the solution being added to the container results in a higher extraction yield of CO₂ into the gas phase from the at least one dissolved inorganic carbon species in the liquid solution phase.

An additional further embodiment includes a gas-liquid contactor comprising a membrane, and at least one molecule on the membrane to increase an interconversion rate of at least one dissolved inorganic carbon species in a solution from a liquid phase to a gas phase as CO₂; where the membrane separates the gas phase and the liquid phase of the at least one dissolved inorganic carbon species; where the at least one molecule is selected from the group consisting of a buffering molecule, a decorated mixed metal oxide, an inorganic coordination compound that mimics a carbonic anhydrase enzyme, a zinc-cyclen, polymer, an amine-based polymer, polyethyleneimine, a photoacid, an excited-state reversible photoacid, a non-reversible photoacid, a metastable photoacid, a photobase, an excited-state reversible photobase, a non-reversible photobase, a metastable photobase, and any combinations thereof.

In another further yet embodiment, the membrane is an anion exchange membrane or a cation exchange membrane.

In yet another embodiment again, the membrane has a cylindrical shape and comprises a material selected from the group consisting of polydimethylsiloxane, polypropylene, polyvinylidene fluoride, polytetrafluoroethylene, polysulfone, polyethersulfone, polyether ether ketone, polyetherimide, polyethylene, and polymethylpentene.

In an additional embodiment, the membrane comprises at least one bundle of the membrane.

In yet another embodiment, the influent solution is titrated to a pH that is lower than the native pH of the influent solution.

In another embodiment again, the liquid phase of the at least one dissolved inorganic carbon species is selected from the group consisting of bicarbonate, carbonate, carbonic acid, aqueous carbon dioxide, and any combinations thereof.

In another additional embodiment, the at least one molecule increases an interconversion rate of bicarbonate dehydration and formation.

In a yet further embodiment again, the at least one molecule is on one side of the membrane that is in contact with the liquid phase.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a schematic of dissolved carbon in the ocean.

FIG. 2 illustrates a schematic of direct ocean capture process.

FIG. 3 illustrates a block diagram for the direct ocean capture process with catalyzed gas-liquid contactors in accordance with an embodiment of the invention.

FIG. 4 illustrates carbon dioxide extraction rate at different influent pH values in accordance with an embodiment of the invention.

FIG. 5 illustrates a catalyzed gas-liquid contactor system in accordance with an embodiment of the invention.

FIG. 6A-6B illustrate experimental setups for characterizing the performance of a gas-liquid contactor in accordance with an embodiment of the invention.

FIG. 7A-7B illustrate carbon dioxide extraction yield at a 0.1 mL/min flow rate in accordance with an embodiment of the invention.

FIG. 8A-8D illustrate carbon dioxide extraction yield at various flow rate in accordance with an embodiment of the invention.

FIG. 9A-9B illustrate carbon dioxide extraction yield with various thickness of anion exchange membrane and cation exchange membrane gas-liquid contactors in accordance with an embodiment of the invention.

FIG. 10 illustrates carbon dioxide extraction yield with various thickness of gas-liquid contactors in accordance with an embodiment of the invention.

FIG. 11 illustrates the structure of the zinc-cyclen molecule.

FIG. 12 illustrates carbon dioxide extraction yield before and after adding sodium phosphate to the solution in accordance with an embodiment of the invention.

FIG. 13 illustrates carbon dioxide extraction yield before and after adding zinc-cyclen to the solution in accordance with an embodiment of the invention.

FIG. 14 illustrates the structure of polyethyleneimine.

FIG. 15A-15B illustrate carbon dioxide extraction yield with bare anion exchange membranes and cation exchange membranes, and spin-coated with catalysts and/or polymers in accordance with an embodiment of the invention.

FIG. 16A-16B illustrates carbon dioxide extraction yield with bare anion exchange membranes, and coated with catalysts and/or polymers in accordance with an embodiment of the invention.

FIG. 16C illustrates average steady state extraction yield of planar membrane contactors with various catalysts in accordance with an embodiment of the invention.

FIG. 17 illustrates carbon dioxide extraction yield with the effect from photoacids in accordance with an embodiment of the invention.

FIG. 18A-18B illustrates carbon dioxide extraction yield with porous PTFE membrane gas-liquid contactor fiber in accordance with an embodiment of the invention.

FIG. 19 illustrates carbon dioxide extraction yield with a single PTFE gas-liquid membrane contactor fiber in accordance with an embodiment of the invention.

FIG. 20 illustrates overnight carbon dioxide extraction yield with a single PTFE gas-liquid membrane contactor fiber in accordance with an embodiment of the invention.

FIG. 21 illustrates average steady state extraction yield and average steady state flux at various flow rate of single fiber membrane contactor in accordance with an embodiment of the invention.

### DETAILED DESCRIPTION OF THE INVENTION

Turning now to the drawings, carbon capture with gas-liquid contactors in accordance with various embodiments are illustrated. In some embodiments, the gas-liquid contactors can be membrane gas-liquid contactors. In certain embodiments, the gas-liquid contactors can be catalyzed. In several embodiments, gas-liquid membrane contactors are used for capturing carbon dioxide through direct ocean capture and/or direct air capture. Carbon capture processes in accordance with many embodiments can capture any dissolved inorganic carbon in a water source including (but not limited to): ocean, river, lake, reservoir, desalinated water, synthetic ocean water, and ocean water mimics. Examples of dissolved inorganic carbon include (but are not limited to): aqueous carbon dioxide, bicarbonate, carbonate, carbonic acid, minerals, and sediments.

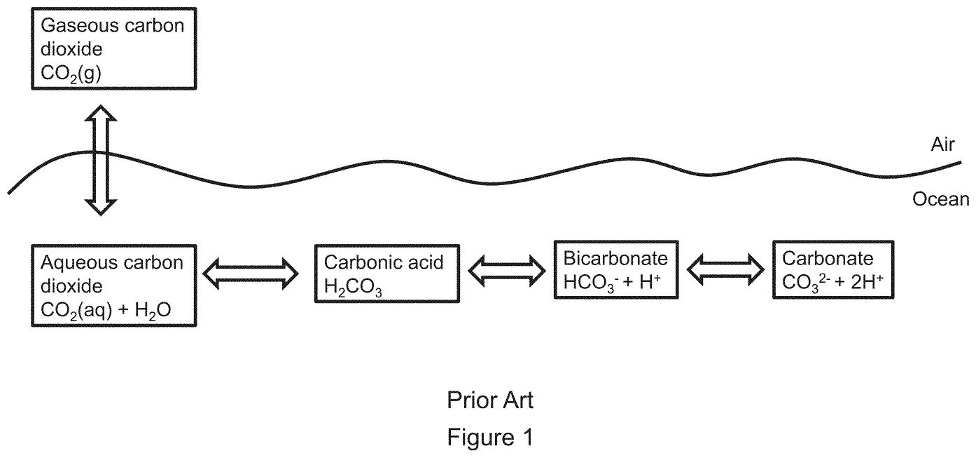

The ocean contains more carbon in the form of dissolved inorganic carbon than CO₂ in the atmosphere. The ocean is the largest inorganic carbon reservoir in exchange with atmospheric carbon dioxide (CO₂) and as a result, the ocean exerts a dominant control on atmospheric CO₂ levels. Dissolved carbon dioxide in the ocean occurs mainly in three inorganic forms: free aqueous carbon dioxide (CO₂(aq)), bicarbonate (HCO₃⁻), and carbonate ion (CO₃²⁻). The majority of dissolved inorganic carbon in the ocean is in the form of HCO₃⁻. FIG. 1 illustrates a schematic of dissolved inorganic carbon in the ocean. When CO₂ gas dissolves in the ocean, it interacts with the water to produce a number of different compounds according to Equation 1:

CO₂ (aq)+H₂O↔H₂CO₃↔H⁺+HCO₃⁻↔2H⁺+CO₃²⁻ (1)

CO₂ reacts with water to produce carbonic acid (H₂CO₃), which then dissociates into bicarbonate (HCO₃⁻) and hydrogen ions (H⁺). Bicarbonate can further dissociate into carbonate (CO₃²⁻) and an additional hydrogen ion.

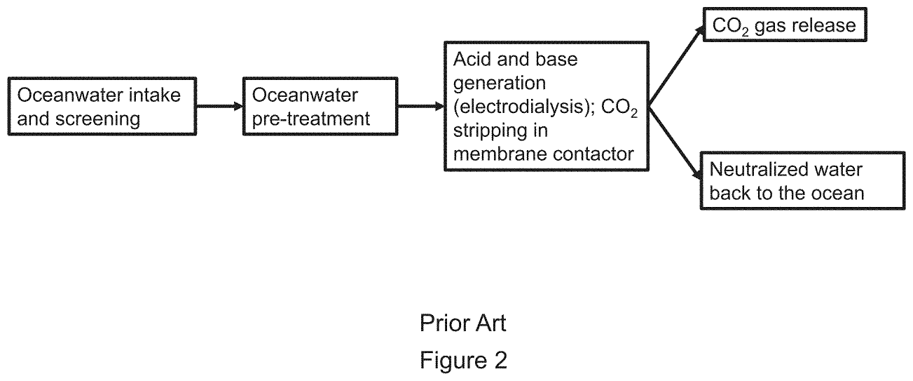

One method for direct ocean capture is to drive the CO₂-bicarbonate balance toward dissolved CO₂ by acidifying the seawater. A liquid-gas membrane contactor may be used to extract gaseous CO₂. This process may need electro-chemical cells that generate acid, with components including electrode compartments, cathodes and anodes, and cation-permeable membranes etc. FIG. 2 illustrates a schematic of an electrochemical oceanwater carbon capture system. Oceanwater has an innate pH of about 8.1. The native oceanwater can be pumped into an oceanwater pretreatment system. The pretreated (or native) oceanwater can be acidified by adding acids to bring the pH down to about 4. The acidified oceanwater can then interact with the gas-liquid membrane contactor to extract gaseous CO₂. The gaseous CO₂ can be pumped out using a vacuum pump. The gaseous CO₂ can be collected for industrial applications and/or other applications. The oceanwater can then be neutralized before returning the partially decarbonized water back to the ocean.

In solvent based carbon capture systems, to achieve efficient carbon capture, high surface area, compact and modular gas-liquid contactors can be used to facilitate the transport of species without mixing of the gas and liquid phases. For example, CO₂ in air with extremely low concentration would require facile mass transport in the gas-liquid contactors to dissolve and absorb into the capture solvents including (but not limited to) KOH or K₂CO₃. Dissolved CO₂ in acidified oceanwater may require gas-liquid contactors to extract dissolved low concentration CO₂ as a stream of CO₂ in the gaseous phase. The operating principle of the gas-liquid membrane contactor includes: a membrane material that is used to provide an interface between the gas and liquid phase and provide efficient contact and efficient species transport (CO₂ and/or dissolved inorganic carbon in the case of carbon capture) between the two phases without direct mixing of the two phases.

Many embodiments provide catalyzed and/or modified membrane materials as gas-liquid membrane contactors to remove dissolved CO₂. The catalyzed membrane contactors enhance the interconversion rate between bicarbonate and CO₂. Several embodiments implement ion exchange membranes as membrane contactors in order to concentrate dissolved inorganic carbon and improve the CO₂ extraction efficiency due to their rapid transport. Due to the improved conversion rate between bicarbonate and CO₂, CO₂ removal may not need to start with acidified oceanwater with pH around 4. In many embodiments, the modified gas-liquid membrane contactors can capture carbon from oceanwater with pH greater than about 4; with pH from about 4 to 8; with pH from about 4 to 6; with pH from about 4 to 5. Several embodiments are able to remove dissolved carbon directly from the oceanwater (pH about 8.1). In a number of embodiments, the modified gas-liquid membrane contactors can capture carbon from air using solvents including (but not limited to) K₂CO₃ (aq.) or KOH (aq.).

Gas-liquid membrane contactors for DOC in accordance with some embodiments can include hollow membrane fibers, bundles of hollow membrane fibers, nano/microporous materials, dense materials, anion exchange membranes, and cation exchange membranes. The hollow membrane fibers may be permeable to the gas phase carbon dioxide. Hollow membrane fiber-based gas-liquid contactors can have large active area per unit volume of the module. The geometric nature of the hollow fiber is highly intrinsically mechanically robust and a range of polymer membrane materials can be used to offer flexibility and easy handling during module fabrication. Examples of hollow membrane fibers include (but are not limited to) polydimethylsiloxane (PDMS), polypropylene (PP), polyvinylidene fluoride (PVDF), polytetrafluoroethylene (PTFE), polysulfone (PSF), polyethersulfone (PES), polyether ether ketone (PEEK), polyetherimide (PEI), polyethylene (PE), and polymethylpentene (PMP).

The anion and/or cation exchange membranes may not be permeable to gaseous carbon oxide, but are able to transport dissolved inorganic carbon including (but not limited to) bicarbonate through the membranes. The anion and/or cation exchange membranes can have various functional groups including (but not limited to) buffer species on the membranes. Examples of functional groups for cation exchange membranes include (but are not limited to) sulfonates. Examples of functional groups for anion exchange membranes include (but are not limited to) quaternary ammoniums (QAs), benzyltrialkylammoniums, alkyl-bound (benzene-ring-free) QAs, and QAs based on bicyclic ammonium systems synthesized using 1,4-diazabicyclo[2.2.2]octane (DABCO) and 1-azabicyclo[2.2.2]octane (quinuclidine, ABCO) (to yield 4-aza-1-azoniabicyclo[2.2.2]octane, and 1-azoniabicyclo[2.2.2]octane {quinuclidinium} functional groups, respectively). Examples of functional groups for anion exchange membranes include (but are not limited to) heterocyclic systems including imidazolium, benzimidazoliums, PBI systems where the positive charges are on the backbone (with or without positive charges on the side-chains), and pyridinium types, guanidinium systems; P-based systems types including stabilized phosphoniums, tris(2,4,6-trimethoxyphenyl) phosphonium, P—N systems, phosphatranium and tetrakis(dialkylamino)phosphonium systems; sulfonium types; metal-based systems where an attraction is the ability to have multiple positive charges per cationic group. Examples of anion exchange membranes include (but are not limited to) SELEMION®, NEOSEPTA®, Fumapem® FAA, Fumasep® FAP, Sustainion® X37, Versogen® PiperION, Ionomr Aemion®. Examples of cation exchange membranes include (but are not limited to) Nafion®.

The gas-liquid membrane contactors in accordance with some embodiments can be modified with functional molecules to enhance the transport of dissolved carbon and/or extraction of the carbon dioxide gas. In several embodiments, the gas-liquid membrane contactors can be modified with catalysts to increase the rates for interconversion of bicarbonate and carbon dioxide. Examples of the functional molecules include (but are not limited to) buffering molecules, decorated mixed metal oxides, inorganic coordination compounds that mimic carbonic anhydrase enzymes, zinc-cyclen, polymers, amine-based polymers, polyethyleneimine (PEI), photoacids, reversible and/or excited-states photoacids, non-reversible photoacids, metastable photoacids, photobases, excited-state reversible photobases, non-reversible photobases, metastable photobases, and any combinations thereof. Such molecular modification may chemically catalyze the interconversion of dissolved inorganic carbon including (but not limited to) bicarbonate to carbon dioxide. In some embodiments, anion exchange membranes can be modified with carbonic anhydrase enzyme mimic, zinc-cyclen, PEI, and/or photoacids. In certain embodiments, hollow membrane fibers can be modified with carbonic anhydrase enzyme mimic, zinc-cyclen, PEI, and/or photoacids. In a number of embodiments, light sources including (but not limited to) lasers and/or light emitting diodes can be used together with the photoacids to enhance rates of interconversion of dissolved inorganic carbon.

The described apparatuses, systems, and methods should not be construed as limiting in any way. Instead, the present disclosure is directed toward all novel and nonobvious features and aspects of the various disclosed embodiments, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatuses can be used in conjunction with other systems, methods, and apparatus.

Systems and methods for catalyzed gas-liquid contactor systems in accordance with various embodiments of the invention are discussed further below.

Catalyzed Gas-Liquid Contactor Systems for CO₂ Removal from High pH Oceanwater

Conventionally, the DOC process pre-treats the native oceanwater (pH at about 8.1) and adds acids to the pre-treated oceanwater to lower the pH to about 4. However, acidification is an extra step and requires the use of acid, thus adding costs to the DOC processes. Many embodiments incorporate catalyst-coated membrane materials including (but not limited to) membrane contactors and/or ionic exchange membranes, to enhance rates for interconversion of bicarbonate and CO₂ and species fluxes. Enhancing the rates of the forward and reverse reactions for interconversion of bicarbonate and CO₂ enables CO₂ removal from an environment with pH values from about 4 to about 8 in accordance with several embodiments. Several embodiments can use oceanwater with a much higher pH (pH greater than about 7) to efficiently remove CO₂. Efficient removal of CO₂ from high pH oceanwater (pH greater than about 7) has several advantages. Removing CO₂ directly from the oceanwater may need the electrodialyzer to produce much less acid and base per captured CO₂. In some instances, capturing CO₂ from oceanwater at pH about 7.1 may need only 1/360^{th} of the oceanwater to be pre-treated, which can lower the electrodialyzer costs.

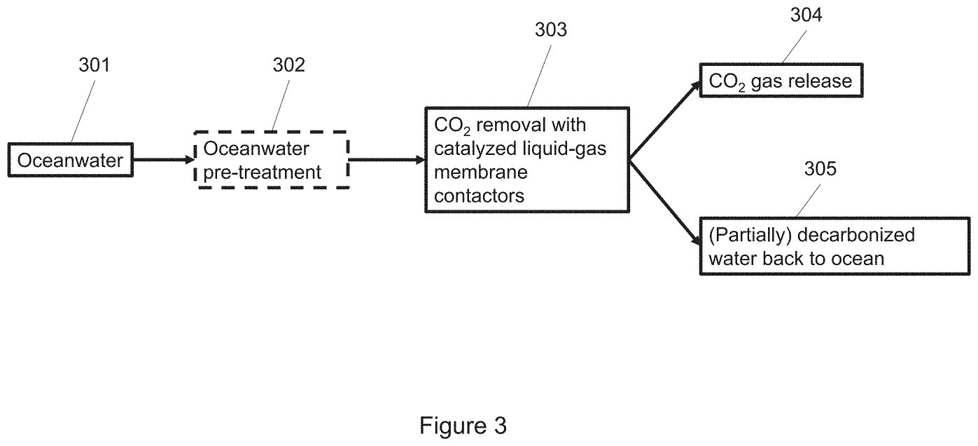

FIG. 3 illustrates a block diagram of CO₂ removal from oceanwater using catalyzed liquid-gas contactors in accordance with an embodiment. Oceanwater can be pumped into the system 301. The oceanwater may be pretreated to lower the pH from about 8.1 to an acidic pH from about 4 to about 6 in 302. In some embodiments, the oceanwater may not need pretreatment to lower the pH. The (acidified) oceanwater can then be flown to catalyzed gas-liquid membrane contactors to separate CO₂ in 303. The gaseous phase CO₂ can be pumped out of the system and collected in 304. The oceanwater with CO₂ removed can be discharged back to the ocean to absorb more CO₂ from the atmosphere in 305.

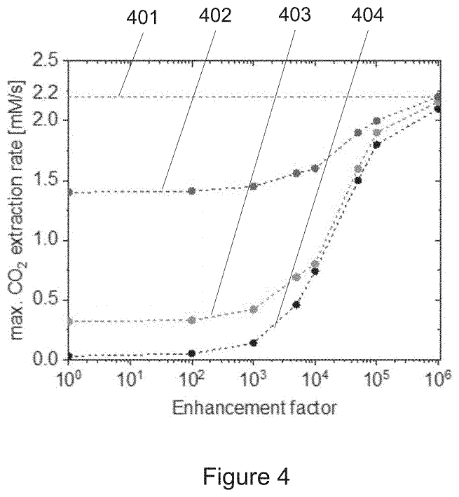

FIG. 4 illustrates simulation results for attainable CO₂ removal rates at different pH values for the acidified oceanwater in accordance with an embodiment of the invention. FIG. 4 illustrates a CO₂ extraction rate at pH about 4 (401), at pH about 6.1 (402), at pH about 7.1 (403), and at pH about 8.1 (404). Enhancing the rates of the forward and reverse reactions for interconversion of bicarbonate and CO₂ by a factor of about 10⁶, the maximum CO₂ removal rate at pH values of 6.1, 7.1, and 8.1 (402, 403, and 404), can be similar to the CO₂ removal rate for acidified oceanwater at pH 4 (401).

While various configurations of catalyzed gas-liquid contactor systems are described above with references to FIG. 3 and FIG. 4, any variety of catalyzed gas-liquid contactor systems can be utilized as appropriate to the requirements of specific applications in accordance with various embodiments of the invention.

### Gas-Liquid Contactors

Several embodiments incorporate bicarbonate dehydration and formation (BDF) catalysts in gas-liquid contactors to accelerate the inherently slow rates for interconversion of bicarbonate and CO₂. In many embodiments, gas-liquid membrane contactors can include catalyst-bonded hollow fiber membrane bundles. Catalysts including (but not limited to) inorganic coordination compounds that mimic carbonic anhydrase enzymes, modified gas-liquid membrane contactor materials can increase interconversion rates of bicarbonate and CO₂. Many embodiments provide integration of functional molecules to catalyst bonded membranes and fiber materials. Examples of the molecules include (but are not limited to) buffering molecules, decorated mixed metal oxides, zinc-cyclen, polymers, amine-based polymers, polyethylenimine (PEI), photoacids, reversible and/or excited-states photoacids, non-reversible photoacids, metastable photoacids, photobases, excited-state reversible photobases, non-reversible photobases, metastable photobases, and any combinations thereof. A number of embodiments use metal-oxide nanomaterial catalysts in the membrane materials as composites to affect the rate of BDF. The metal-oxide nanomaterial catalysts can increase rates of water dissociation in bipolar membranes.

In many embodiments, microporous hollow fibers can be woven into the fabric bundles to increase the surface area. Some embodiments use chemical grafting and/or mixing with membrane materials including (but not limited to) polypropylene and polydimethylsiloxane, into the membrane contactors to incorporate BDF catalysts. The catalysts can be incorporated at the shell or lumen side of the hollow fiber membranes. In certain embodiments, catalyst materials can be coated on the shell side of the hollow fibers so that (acidified) oceanwater is in contact with BDF catalysts. In addition, the shell side and/or the lumen side of the hollow fibers may have enhanced surface area compared to planar structures. A vacuum may be applied on the other side (such as the lumen side) and remove the CO₂. The low concentration of dissolved CO₂ may impact the optimal diameter of the membrane, as well as flow rates and vacuum condition. Owing to the short diffusional distance in the membrane contactor and the relatively fast interconversion rate between bicarbonate and CO₂, the oceanwater behaves as a reservoir of dissolved CO₂ within the hollow membrane fiber material. Regeneration/reactivation strategies for membranes that exhibit decreased activity over time include rapid pulse flushing using dilute salt water and acid/base from the electrodialzyer stack and solar-thermal heating. Multiphysics models can be used to optimize the spatial location of catalysts, thicknesses of membranes, charge densities in anion exchange and cation exchange membranes, flow rates of acidified oceanwater in hollow fiber materials, oceanwater pH and gas partial pressure in the membrane contactor, and associated number of vacuum pumps.

In some embodiments, gas-liquid membrane contactors may include catalyst-bonded anion and/or cation exchange membranes. The catalysts modified ion exchange membranes include (but are not limited to) anion exchange membranes and cation exchange membranes that can allow for concentration and transport of bicarbonate across the membrane, whose fluxes can be considerably higher than those of CO₂ at non-extreme pH values, followed by catalytic release of CO₂.

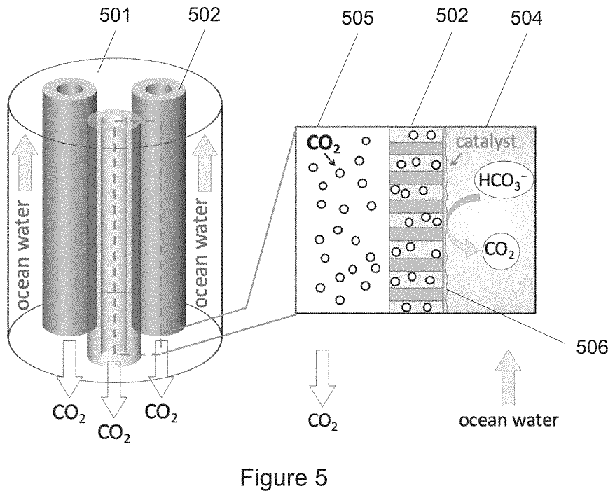

FIG. 5 illustrates a schematic of a catalyzed gas-liquid contactor in accordance with an embodiment of the invention. A gas-liquid contactor 501 can include bundles of hollow fiber membranes 502. A zoom in illustration of the gas-liquid contactor interface is also shown. The hollow fiber membrane 502 can have a shell side 504 and a tube or lumen side 505. The shell side 504 interfaces with the oceanwater and is in liquid phase. The hollow fiber membrane 502 can be a gas permeable membrane. The tube side 505 interfaces CO₂ gas phase at reduces pressure. The catalysts 506 can be coated on the shell side 504 of the hollow fiber membrane to interface the oceanwater. Bicarbonate ions in the oceanwater can be converted to dissolved CO₂ at an accelerated rate due to the catalyst. The CO₂ gas can transport through the gas permeable membrane 502 and enters the lumen or the tube side of the hollow fiber membrane to be collected.

In certain embodiments, 502 can be ion exchange membranes, such as anion exchange membranes or cation exchange membranes. The ion exchange membranes may not be permeable to CO₂ gas, but bicarbonate ions and/or dissolved CO₂ (aq) can transport through the membranes. The catalyst deposited on the membrane can expedite the conversion of bicarbonate ions to CO₂. The catalyst can be deposited on the lumen side and/or the shell side of the ion exchange membranes.

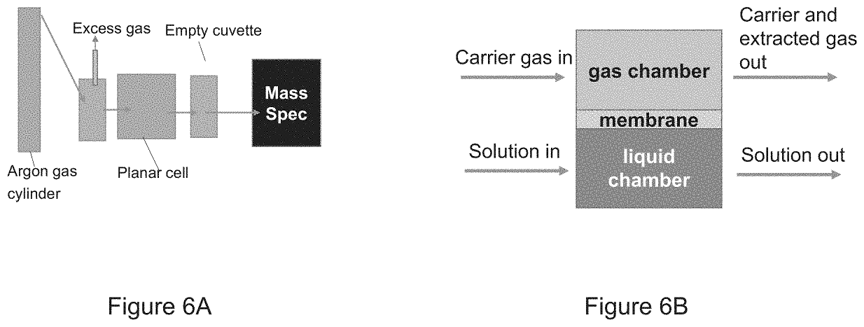

Several embodiments provide catalyst-bonded anion and/or cation exchange membranes as gas-liquid membrane contactors. An experimental setup can be used to show how various factors such as, flow rate of the oceanwater, types of ion exchange membranes, thickness of the membranes, can affect CO₂ extraction from solution. FIG. 6A illustrates an experimental setup for characterizing the performance of a gas-liquid contactor in accordance with an embodiment. A planar cell can be used to characterize the membrane contactor performance. A mass spectrometer can be used to measure the amount of the extracted CO₂. FIG. 6B illustrates a schematic of the planar cell in accordance with an embodiment. The planar cell can include a gas chamber and a liquid chamber. An ion exchange membrane can be placed in between the two chambers. The membrane can be made of at least one hollow fiber membrane. A carrier gas such as an inert gas can be flown into the gas chamber. A solution such as the oceanwater or an oceanwater mimic can be flown into the liquid chamber. An outlet is attached to the gas chamber to let out the extracted gas and the carrier gas. An outlet is attached to the liquid chamber to let out the solution.

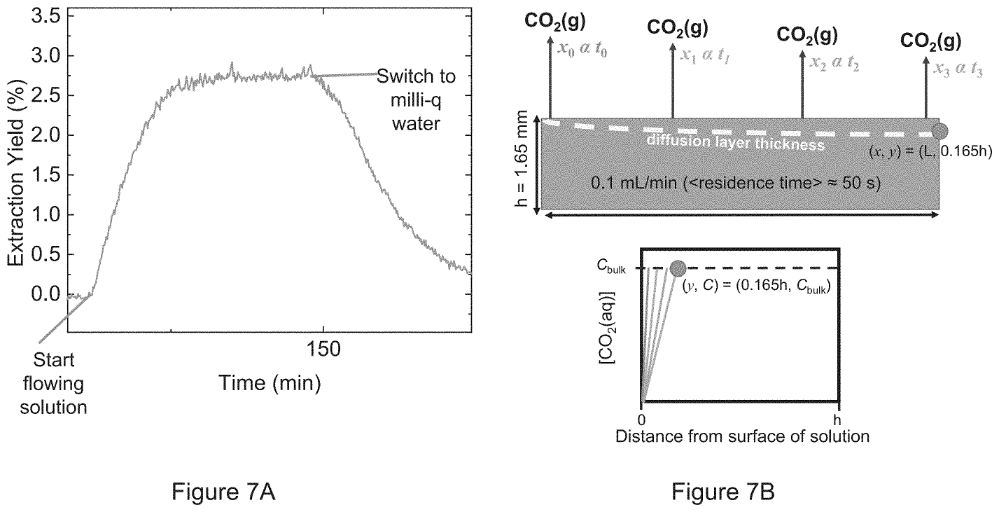

Certain embodiments use synthetic solutions to determine CO₂ extraction rate. The flow rate of carrier gas containing a range of CO₂ partial pressures can be varied to analyze the kinetics of how CO₂ is released from a small-volume aqueous solution containing bicarbonate and different buffering groups. In several embodiments, a slower flow rate of the solution can result in a higher CO₂ extraction. Some embodiments use cation exchange membranes including (but not limited to) Nafion®. FIG. 7A-7B illustrate CO₂ extraction yield at a flow rate of about 0.1 mL/min in accordance with an embodiment of the invention. A 2.2 mM sodium bicarbonate solution with a pH about 6 is used. About 40% of dissolved inorganic carbon (DIC) in the solution is CO₂ (aq). A cation exchange membrane with a thickness of about 50 μm, is used as the gas-liquid membrane contactor. The solution volume is about 0.08 mL, and the flow rate is about 0.1 mL/min. FIG. 7A shows a steady-state CO₂ extraction yield of about 2.75% with about 0.1 mL/min flow rate. New incoming DIC equilibrates over time, eventually reaching a steady state of extraction. FIG. 7B provides a visualization of expected approximate CO₂ (aq) concentration profiles at distances, xi, along the length of the gas liquid contactor at steady state.

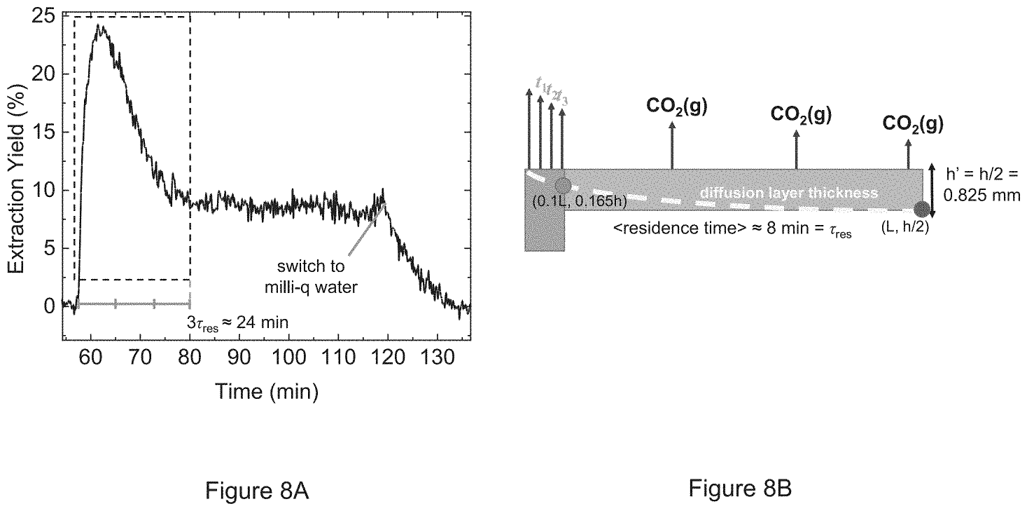

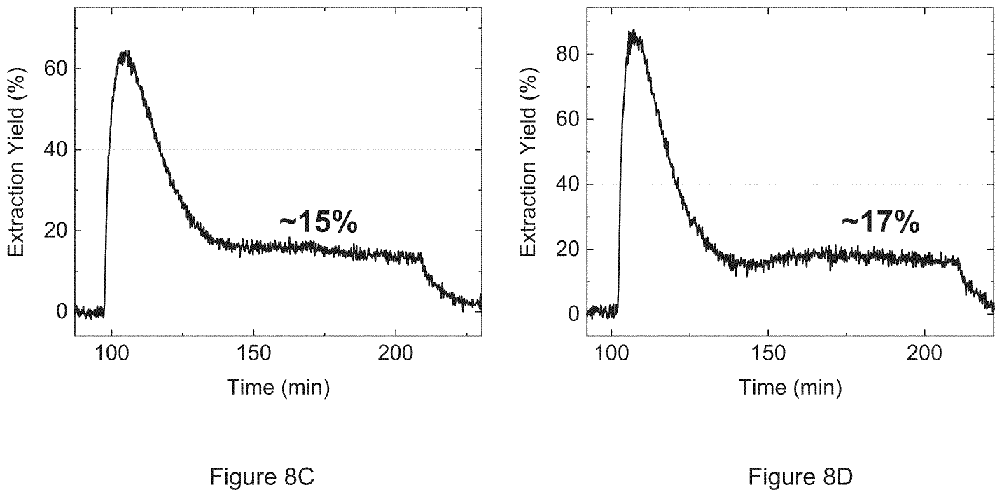

FIG. 8A-8B illustrate CO₂ extraction yield at a flow rate of about 0.005 mL/min in accordance with an embodiment of the invention. A 2.2 mM sodium bicarbonate solution with a pH about 6 is used. About 40% of dissolved inorganic carbon (DIC) in the solution is CO₂ (aq). A cation exchange membrane with a thickness of about 50 μm, is used as the gas-liquid membrane contactor. The solution volume is about 0.04 mL, and the flow rate is about 0.005 mL/min. FIG. 8A shows a steady-state CO₂ extraction yield of about 10% with about 0.005 mL/min flow rate. The peak in the dashed box is a measurement artifact of the experiment. FIG. 8B provides a visualization of expected approximate CO₂ (aq) concentration profiles along the length of the gas liquid contactor. FIG. 8B shows CO₂ (aq) concentration profiles at distances, xi, along the length of the gas liquid contactor at steady state. With a reduced flow rate (residence time increased), extraction yield of CO₂ may increase.

FIG. 8C illustrates CO₂ extraction yield at a flow rate of about 0.003 mL/min in accordance with an embodiment of the invention. A 2.2 mM sodium bicarbonate solution with a pH about 6 is used. About 40% of dissolved inorganic carbon in the solution is CO₂ (aq). A cation exchange membrane with a thickness of about 50 μm, is used as the gas-liquid membrane contactor. The flow rate is about 0.003 mL/min. FIG. 8C shows a steady-state CO₂ extraction yield of about 15% with about 0.003 mL/min flow rate. While extraction yield increases with slower flow rate, flux of CO₂ across the membrane decreases.

FIG. 8D illustrates CO₂ extraction yield at a flow rate of about 0.002 mL/min in accordance with an embodiment of the invention. A 2.2 mM sodium bicarbonate solution with a pH about 6 is used. About 40% of dissolved inorganic carbon in the solution is CO₂ (aq). A cation exchange membrane with a thickness of about 50 μm, is used as the gas-liquid membrane contactor. The flow rate is about 0.002 mL/min. FIG. 8D shows a steady-state CO₂ extraction yield of about 17% with about 0.002 mL/min flow rate. While extraction yield increases with slower flow rate, flux of CO₂ across the membrane decreases.

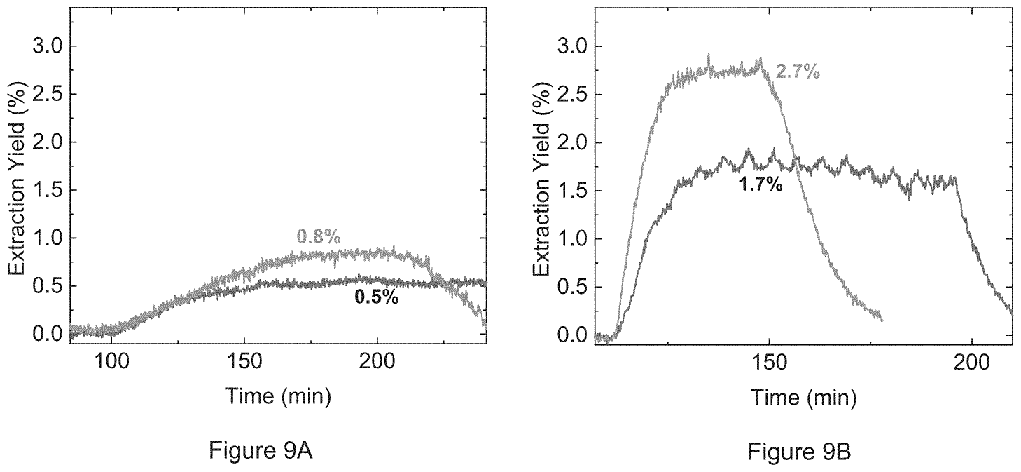

In several embodiments, the major species transporting across the ion exchange membranes is CO₂ (aq), while for others it is bicarbonate or carbonate. Many embodiments provide that the thicker the ion exchange membrane, the lower the CO₂ extraction yield. Some embodiments provide that when there is excess salt, the extraction yield may be lower. Some embodiments use anion exchange membranes including (but not limited to) SELEMION®, NEOSEPTA®, Fumapem® FAA, Fumasep® FAP, Sustainion® X37, Versogen® PiperION, Ionomr Aemion®, and cation exchange membranes including (but not limited to) Nafion®. FIG. 9A illustrates CO₂ extraction yield with an anion exchange membrane in accordance with an embodiment of the invention. A 2.2 mM NaHCO₃ solution with a pH about 6, and a 2.2 mM NaHCO₃ and 100 mM NaClO₄ solution with a pH about 6, are used. An anion exchange membrane with a thickness of about 220 μm, is used as the gas-liquid membrane contactor. The NaHCO₃ solution setup has a steady-state CO₂ extraction yield of about 0.8%. The NaHCO₃ and NaClO₄ solution setup has a steady-state CO₂ extraction yield of about 0.5%.

FIG. 9B illustrates CO₂ extraction yield with a cation exchange membrane in accordance with an embodiment of the invention. A 2.2 mM NaHCO₃ solution with a pH about 6, and a 2.2 mM NaHCO₃ and 100 mM NaClO₄ solution with a pH about 6, are used. A cation exchange membrane with a thickness of about 50 μm, is used as the gas-liquid membrane contactor. The NaHCO₃ solution setup has a steady-state CO₂ extraction yield of about 2.7%. The NaHCO₃ and NaClO₄ solution setup has a steady-state CO₂ extraction yield of about 1.7%. Both FIG. 9A and FIG. 9B show the electrolyte with less salt shows a higher CO₂ extraction yield. A thinner cation exchange membrane also shows a higher CO₂ extraction yield than the thicker anion exchange membrane.

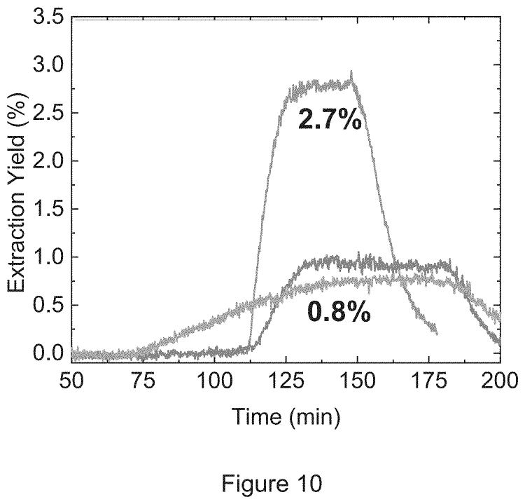

Some embodiments provide the mass transfer limit when using a thicker membrane: the thicker the membrane, the lower the extraction yield. Supported thinner membranes can be used to overcome slow rates of CO₂ transport across the gas-liquid contactor limit. FIG. 10 illustrates CO₂ extraction yield with cation exchange membranes and anion exchange membranes of various thickness in accordance with an embodiment of the invention. A 2.2 mM sodium bicarbonate solution with a pH about 6 is used as the electrolyte. Cation exchange membrane with a thickness of about 50 μm, and a thickness of about 254 μm, are used as the gas-liquid membrane contactors. An anion exchange membrane with a thickness of about 220 μm, is used as the gas-liquid membrane contactor. The 50 μm thick cation exchange membrane shows a steady-state CO₂ extraction yield of about 2.7%. The 254 μm thick cation exchange membrane and the 220 μm thick anion exchange membrane have comparable steady-state CO₂ extraction yield of about 0.8%.

While various gas-liquid contactors are described above with references to FIG. 5-FIG. 10, any variety of gas-liquid contactors can be utilized as appropriate to the requirements of specific applications in accordance with various embodiments of the invention.

### Catalyzed Gas-Liquid Contactors

Several embodiments incorporate bicarbonate dehydration and formation (BDF) catalysts in gas-liquid contactors to accelerate the inherently slow rates for interconversion of bicarbonate and CO₂. Natural photosynthetic organisms overcome the inherently slow rate of CO₂ dissolution to form bicarbonate using carbonic anhydrase, with a catalytic rate enhancement on the order of about 10⁷. This reaction proceeds via a hydroxylated intermediate that ultimately transfers OH⁻ to CO₂ via a rate-limiting step of water dissociation. Buffering groups with pKₐ at about 7 exhibit a rapid catalysis of water dissociation and formation (WDF). The active site of carbonic anhydrase contains a Zn(II)—OH cofactor whose conjugate base has pKₐ about 6. Therefore, buffering groups—including metal cations like Zn(II)—and polymers developed for the WDF processes can also be effective for catalysis of BDF.

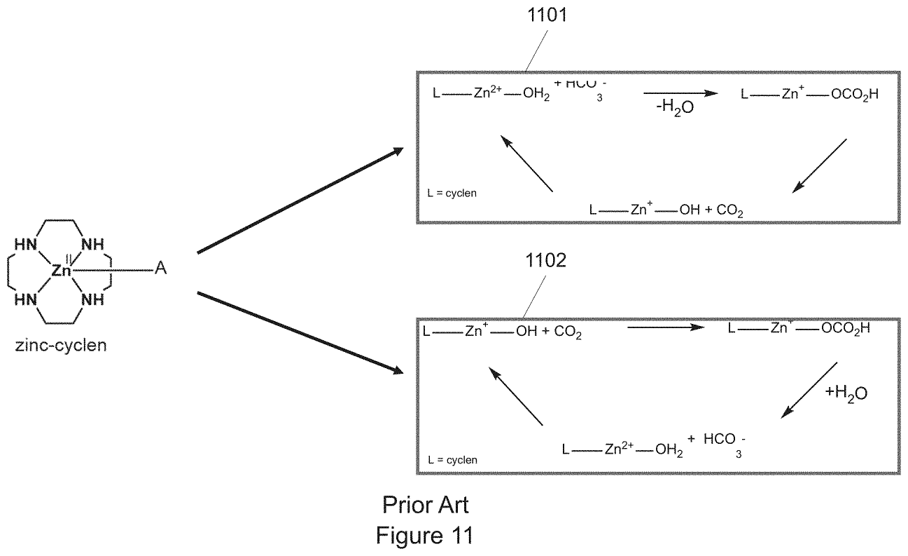

Many embodiments use synthetic catalysts to increase the rate of forward and reverse bicarbonate to CO₂ reactions so as to enhance the rates of oceanic CO₂ removal. In several embodiments, synthetic carbonic anhydrase mimics can be used as BDF catalysts. The synthetic BDF catalysts can function in homogeneous solution and/or at heterogeneous interfaces to enhance the interconversion of bicarbonate and CO₂. Several embodiments use Zn(II)(cyclen) small-molecule carbonic anhydrase mimic BDF catalyst to enhance the rate for interconversion of bicarbonate and CO₂. Cyclen stands for 1,4,7,10-tetraazacyclododecane. FIG. 11 illustrates the structure of zinc(II)-cyclen. When the surrounding pH is below 7, group A of zinc(II)-cyclen represents water molecules, where the pKₐ is about 7.9. When the pH is below 7, zinc(II)-cyclen catalyzes the dehydration of bicarbonate groups into dissolved CO₂ (1101). When the surrounding pH is above 7, group A represents hydroxyl groups, OH⁻. Monovalent anions may decrease catalytic activity of Zn-cyclen during dehydration of bicarbonate, therefore NaClO₄ can be used instead of NaCl in synthetic oceanwater solutions.

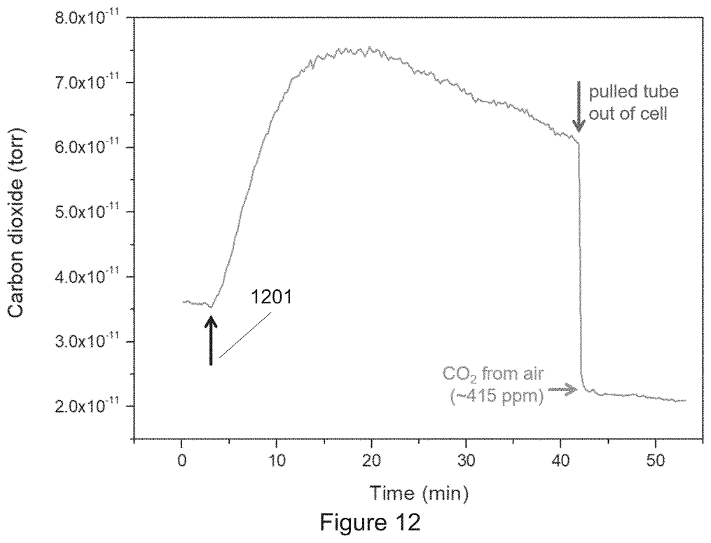

FIG. 12 illustrates CO₂ (m/z=44) concentration change before and after the addition of sodium phosphate WDF/BDF catalysts to aqueous NaHCO₃ solution in accordance with an embodiment. FIG. 12 shows the measurement of CO₂ released from a solution via inline mass spectrometry upon addition of a phosphate (pKₐ≈7). The test solution is 0.5 mL of 2 mM NaHCO₃ solution (pH about 7.0). The arrow 1201 indicates the injection of about 0.1 mL of 2 mM sodium phosphate (pH about 7.0) to make 0.6 mL of 0.3 mM sodium phosphate and 1.7 mM NaHCO₃ (pH about 7.0) solution. Inline mass spectrometry can be used to rapidly evaluate CO₂ extraction efficiency from solutions with small-molecule carbonic anhydrase mimics, photoacids or photobases, or different buffering groups, whose pKₐ values span from about 3.5 to about 10.0 and over a variety of concentrations and pH conditions. 1-3 buffering group combinations may relax pKₐ constraints to achieve rapid rates of BDF.

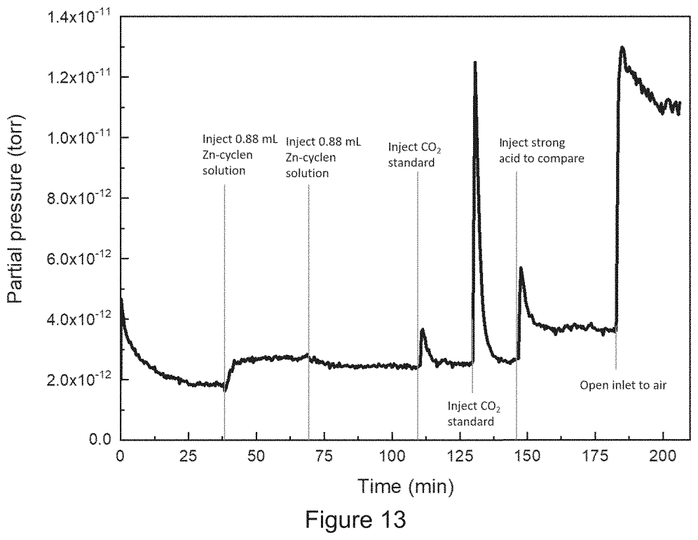

FIG. 13 illustrates CO₂ concentration change before and after addition of Zn(II) cyclen BDF catalysts to simulated oceanwater in accordance with an embodiment of the invention. The test solution (about 0.12 mL) mimics the oceanwater containing aqueous 2.2 mM NaHCO₃ and about 0.1 M NaClO₄ (pH about 8.1). The second standard injection of CO₂ is with a larger volume of CO₂. FIG. 13 shows that the WDF/BDF catalyst Zn(II)-cyclen can enhance the rate for interconversion of bicarbonate and CO₂ via BDF.

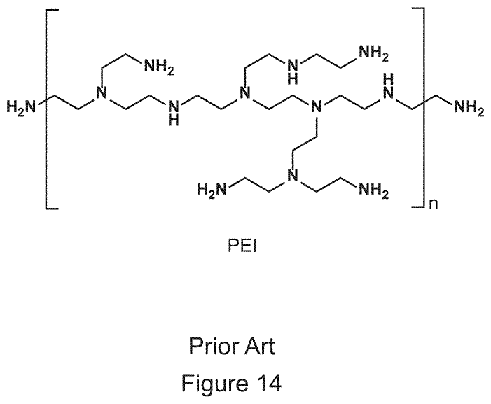

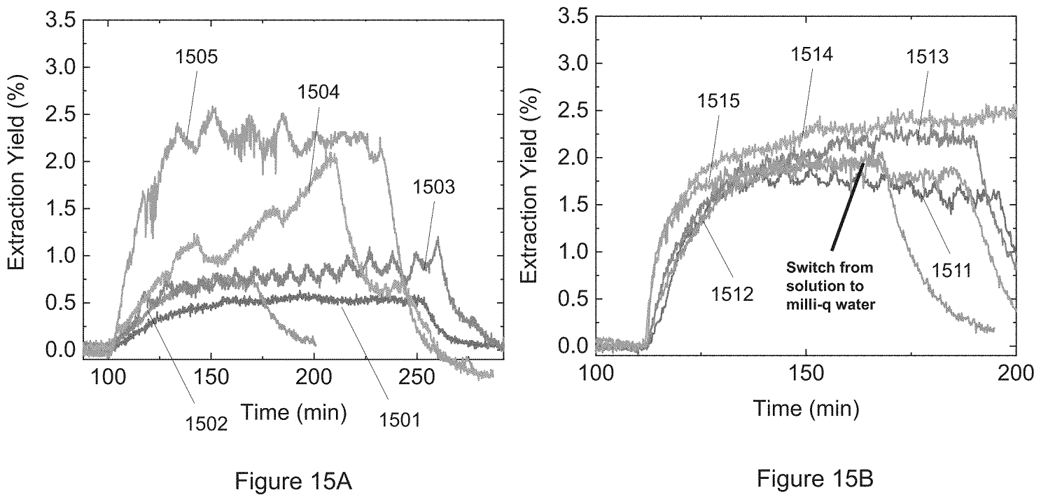

Several embodiments use ion exchange membranes coated with catalysts and/or polymers as gas-liquid contactors. In some embodiments, polyethylenimine (PEI) can be used to coat ion exchange membranes. FIG. 14 illustrates the structure of PEI. FIG. 15A illustrates CO₂ extraction yield using anion exchange membranes spin-coated with catalysts and/or PEI polymers in accordance with an embodiment of the invention. A 2.2 mM sodium bicarbonate and 100 mM NaClO₄ solution with a pH about 6 is used. An anion exchange membrane with a thickness of about 220 μm, is used as the gas-liquid membrane contactor. 1501 shows the bare anion exchange membrane (AEM). 1502 shows the 0.1 wt % catalyst Zn(II)-cyclen coated AEM. 1503 shows the 3.0 wt % catalyst Zn(II)-cyclen coated AEM. 1504 shows 0.1 wt % PEI and Zn coated AEM. 1505 shows 0.1 wt % PEI coated AEM. CO₂ (aq) seems to be the major species transporting across the AEM due to its rapid conversion into gaseous CO₂ at the AEM/gas interface. The polymer and/or catalysts coating on the AEM enhances the CO₂ extraction yield. The PEI coating 1505 achieves a highest CO₂ extraction yield. The catalyst coating 1502 and 1503 both achieve a higher CO₂ extraction yield than the bare AEM. Bicarbonate anions are concentrated in the AEM. Therefore, at the AEM/gas interface, the bicarbonate is able to react with the deposited catalyst and/or polymer. In the PEI-Zn coated AEM 1504, the extraction yield is increasing over time. This is possibly due to the zinc precipitating out of the polymer (reacting to make Zn(OH)₂). This can cause the amines in the PEI polymer to be free to react with the bicarbonate to generate CO₂.

FIG. 15B illustrates CO₂ extraction yield using cation exchange membranes spin-coated with catalysts and/or PEI polymers in accordance with an embodiment of the invention. A 2.2 mM sodium bicarbonate and 100 mM NaClO₄ solution with a pH about 6 is used. A cation exchange membrane, Nafion, with a thickness of about 50 μm, is used as the gas-liquid membrane contactor. 1511 shows the bare cation exchange membrane (CEM). 1512 shows the 0.1 wt % catalyst Zn(II)-cyclen coated CEM. 1513 shows the 3.0 wt % catalyst Zn(II)-cyclen coated CEM. 1514 shows 0.1 wt % PEI and Zn coated CEM. 1515 shows 0.1 wt % PEI coated CEM. CO₂ (aq) seems to be the major species transporting across the CEM due to its rapid conversion into gaseous CO₂ at the CEM/gas interface and lower pH in the CEM. When the CEM is coated with polymers and/or catalysts, no significant increase in extraction yield compared to the bare CEM membrane is observed.

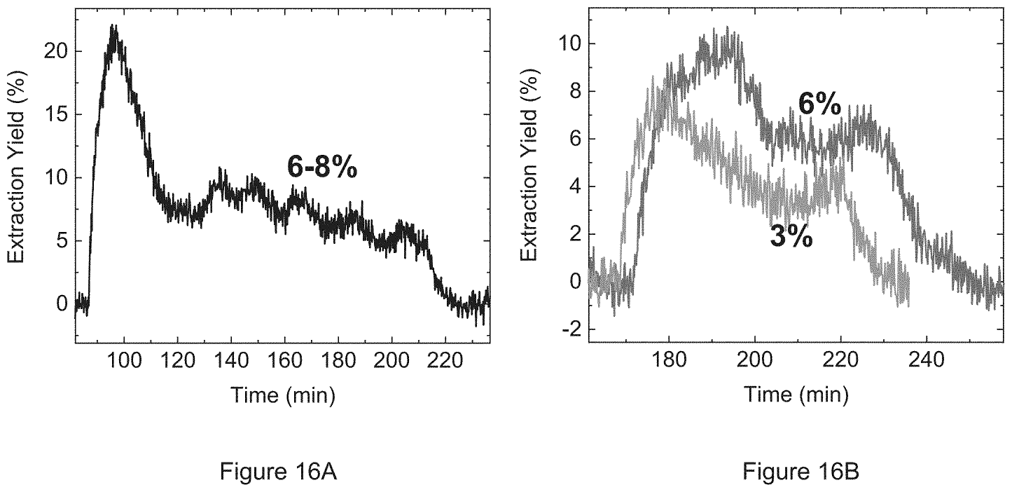

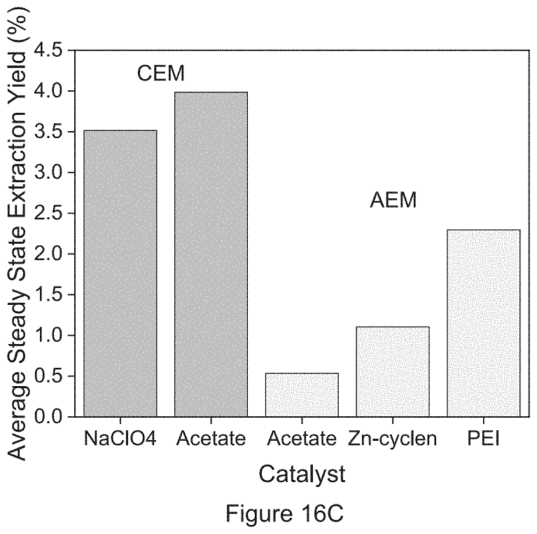

FIG. 16A illustrates CO₂ extraction yield using anion exchange membranes as the gas-liquid contactor in accordance with an embodiment. An AEM with a thickness of about 220 μm, is used as the gas-liquid membrane contactor. A 2.2 mM sodium bicarbonate solution with a pH about 6 is used. The flow rate is about 0.005 mL/min. FIG. 16A shows a steady-state CO₂ extraction yield of about 6-8% with about 0.005 mL/min flow rate.

FIG. 16B illustrates CO₂ extraction yield using anion exchange membranes spin-coated with PEI polymers in accordance with an embodiment. An AEM with a thickness of about 220 μm, is used as the gas-liquid membrane contactor. About 0.1 wt % PEI is deposited on the AEM. The flow rate is about 0.005 mL/min. A 2.2 mM sodium bicarbonate solution with a pH about 6 achieves a steady-state CO₂ extraction yield of about 6%. A 2.2 mM sodium bicarbonate and 100 mM NaClO₄ solution with a pH about 6 achieves a steady-state CO₂ extraction yield of about 3%.

FIG. 16C illustrates average steady state extraction yield of planar of planar membrane contactors with various catalysts in accordance with an embodiment of the invention. FIG. 16C shows both CEMs (about 50 μm thick) and AEMs (about 220 μm thick). The solution is about 2.2 mM DIC and about 100 mM salt, with a pH of about 6. The flow rate is about 0.1 mL/min. CEMs shows better performance than AEMs. The CEMs are about 4 times thinner than the AEMs and CO₂ mass-transfer may be limited. The concentrating H⁺ may shift from HCO³⁻ to CO₂. In terms of catalytic enhancement properties, acetate performs better than NaClO₄ for CEMs. Acetate may mediate proton transfer. For AEMs, N-containing polyethylenimine (PEI) performs better than Zn-cyclen, and Zn-cyclen performs better than acetate. Zn-cyclen carbonic anhydrase mimic can catalyze HCO³⁻ conversion to CO₂.

Photocatalytic photoacids and photobases can reversibly release and/or bind protons when illuminated. Many embodiments incorporate photoacids and/or photobases in gas-liquid membrane contactors. In several embodiments, a light source including (but not limited to) light from the sun or an inexpensive LED source, can be used for direct transient changes in pH to drive CO₂ capture. Certain embodiments use photoacids that are operative at pH about 7. Examples of the photoacids include (but are not limited to) the trisodium salt of 8-hydroxypyrene-1,3,6-trisulfonate (HPTS). For sufficient steady-state pH changes under unconcentrated terrestrial sunlight illumination, photoacids and/or photobases with a larger range of pKₐ values in their ground state and excited state, and/or longer excited-state lifetimes, can be used.

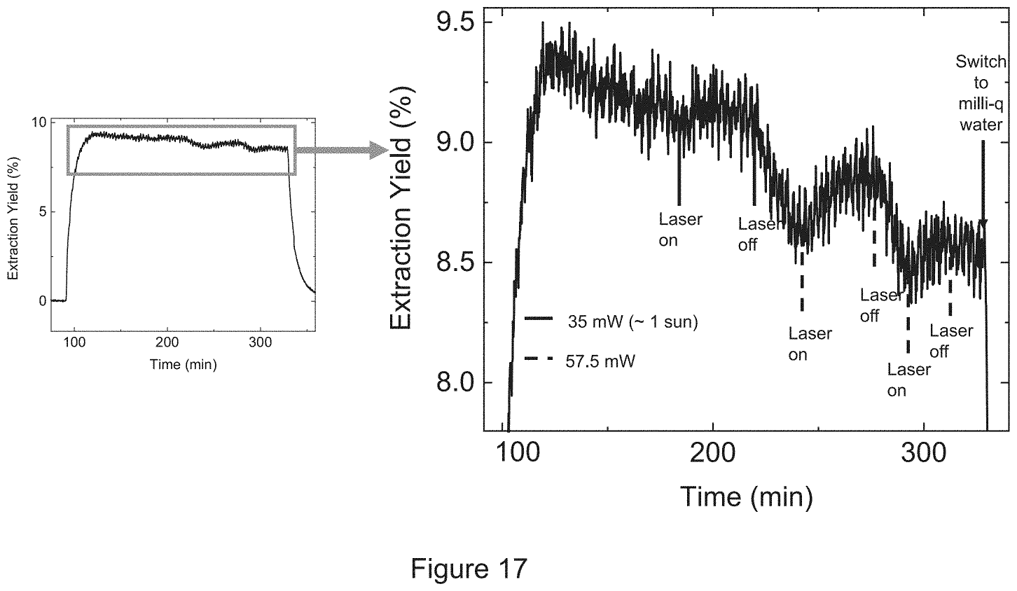

FIG. 17 illustrates CO₂ extraction yield using photoacids with gas-liquid contactors in accordance with an embodiment. A 2.2 mM sodium bicarbonate and 59 μM HPTS solution with a pH about 6 is used. The photoacid HPTS has a pKₐ of about 7.4. A cation exchange membrane, Nafion, with a thickness of about 50 μm, is used as the gas-liquid membrane contactor. The flow rate is about 0.1 mL/min. A 405 nm wavelength laser is used to switch on the photoacid molecules. The CO₂ extraction yield is almost 10%. The photoacid may affect the extraction yield while still in the dark. In the zoom in figure, the laser of about 35 mW power is turned on when the signal begins to decrease. The signal stops decreasing and becomes steadier. When the laser is turned off, the signal begins to decay more rapidly. When the laser of about 57.5 mW power is turned back on, the signal begins to increase again.

Many embodiments provide combinations of small-molecule carbonic anhydrase mimics, photoacids or photobases, and/or different buffering groups to improve the interconversion rate of bicarbonate and CO₂. The functional molecules can be covalently bound to an ionomer and/or covalently incorporated into ion-exchange membranes and gas-liquid membrane contactors. Several embodiments apply small electric fields and large electric fields to the catalyzed gas-liquid contactors. In certain embodiments, polymer polarity may be tuned via chemical modification to enable specificity for CO₂ through variations in equilibrium constant for absorbing CO₂ from oceanwater, with the aim of achieving moderate binding strength to speeding up the conversion of dissolved CO₂ into gaseous CO₂ under minimal vacuum or flow conditions.

The conversion of dissolved CO₂ into gaseous CO₂ may be slow. Several embodiments position BDF catalysts at the gas/liquid interface via covalent bonding to polymers to enhance the conversion to gaseous CO₂. The covalent bonds between the catalysts and the polymer may help disrupt interfacial water hydrogen-bonding networks and decrease surface tension.

In some embodiments, catalytic rates for overall BDF can be enhanced by increasing local temperature. Increasing local temperature can also lower CO₂ solubility. High-efficiency photovoltaics utilize approximately half of the photons in the solar spectrum. Transmitted infrared radiation through commercial bifacial solar cells can be harvested by an infrared radiation absorbing photonic layer that locally heats the membrane contactor to facilitate CO₂ release.

The catalyst modified gas-liquid contactors can generate gaseous carbon dioxide with high purity. Several embodiments provide the system can generate gaseous CO₂ at about 1 bar with greater than about 70% purity. An output CO₂ purity of about 95% can be achieved by pre-degassing oceanwater without acidification before pumping it through a membrane contactor. Deoxygenation is a mature process when removing CO₂ from acidified oceanwater. Degassing oceanwater can enable high-performance gas-liquid contactors.

In order to improve the purity of the extracted gaseous carbon dioxide, certain embodiments include two regions in the integrated membrane contactors. In the two-region membrane contactors, the removal of other dissolved gases can occur first in a region devoid of catalysts, followed by CO₂ removal in a downstream region containing bonded catalysts. In certain embodiments, by first flowing oceanwater through regions of the membrane contactor that do not contain BDF catalysts, O₂ and N₂ can be purged, such that in subsequent catalyst-containing regions, CO₂ release may only be accompanied by water vapor generation. In a number of embodiments, membrane anti-fouling and subsequent decontamination can be performed using periodic gas purging processes.

While various configurations of catalyzed gas-liquid contactors are described above with references to FIG. 11-FIG. 17, any variety of catalyzed gas-liquid contactors can be utilized as appropriate to the requirements of specific applications in accordance with various embodiments of the invention.

### EXEMPLARY EMBODIMENTS

The following discussion sets forth embodiments where the catalyzed gas-liquid membrane contactors in accordance with embodiments may find particular application. It will be understood that these embodiments are provided only for exemplary purposed and are not meant to be limiting.

### Example 1: Fiber Gas-Liquid Contactor

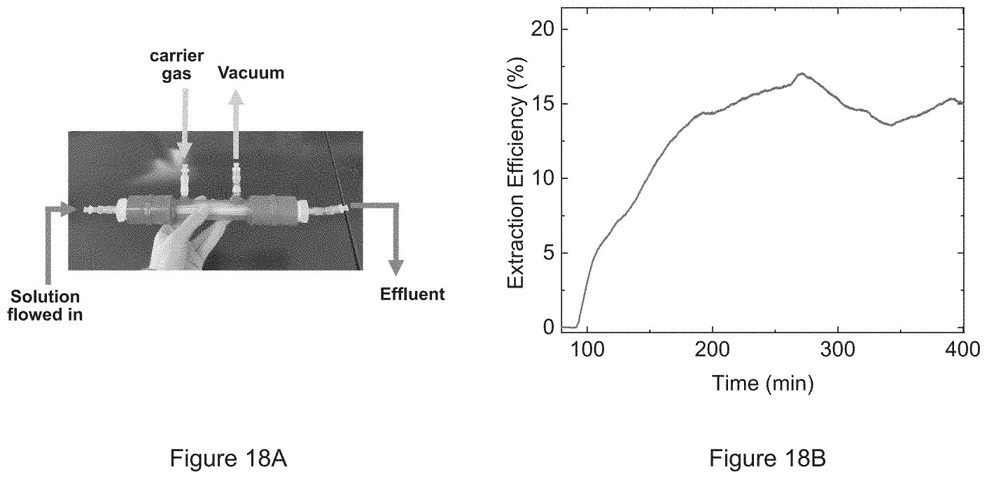

Many embodiments provide gas-liquid membrane contactors with fiber materials including (but not limited to) porous polytetrafluoroethylene as the membrane materials. FIG. 18A illustrates a custom PTFE gas-liquid membrane contactor fiber in accordance with an embodiment. The solution can be flown in by a syringe pump, and an effluent can be collected. An argon carrier gas at about 1 atm can be pulled in by a mass spec system via vacuum pumps and the gas is analyzed to determine CO₂ extraction yield. FIG. 18B illustrates CO₂ extraction yield using a bundle of 13 PTFE gas-liquid membrane contactor fibers in accordance with an embodiment. The membrane material includes PTFE fibers with greater than about 85% porosity. A 2.2 mM sodium bicarbonate and 100 mM NaClO₄ solution with a pH about 6 is used. The flow rate is about 0.7 mL/min. The pH of the influent solution is about 6.0. The pH of the effluent solution is about 6.7 due to the CO₂ removal.

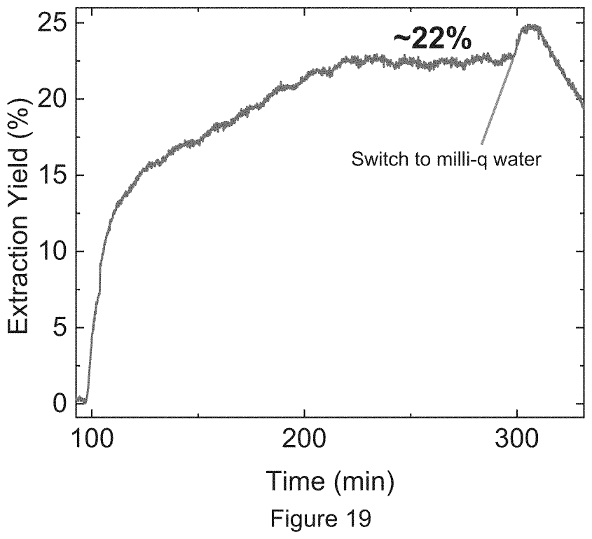

FIG. 19 illustrates CO₂ extraction yield using a single PTFE gas-liquid membrane contactor fiber in accordance with an embodiment. The membrane material includes porous PTFE. A 2.2 mM sodium bicarbonate and 100 mM NaClO₄ solution with a pH about 6 is used. The flow rate is about 0.04 mL/min. FIG. 19 shows a steady-state CO₂ extraction yield of about 22%.

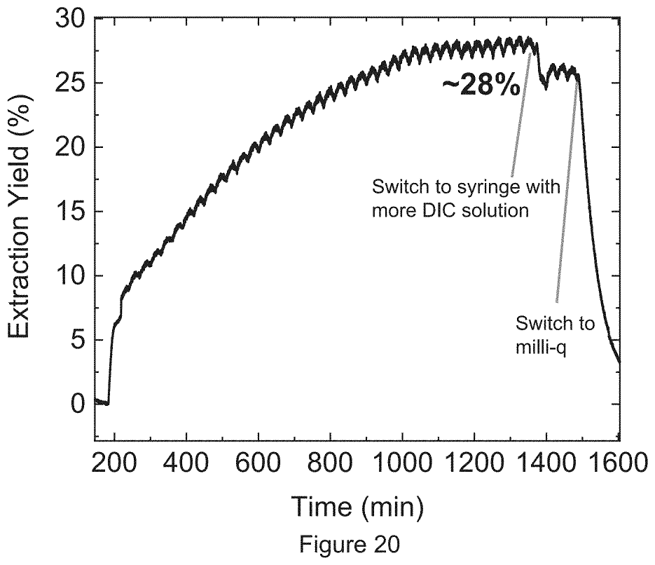

FIG. 20 illustrates CO₂ extraction yield overnight using a single PTFE gas-liquid membrane contactor fiber in accordance with an embodiment. The membrane material includes porous PTFE fibers. A 2.2 mM sodium bicarbonate and 100 mM NaClO₄ solution with a pH about 6 is used. The flow rate is about 0.04 mL/min. FIG. 20 shows a steady-state CO₂ extraction yield of about 28%.

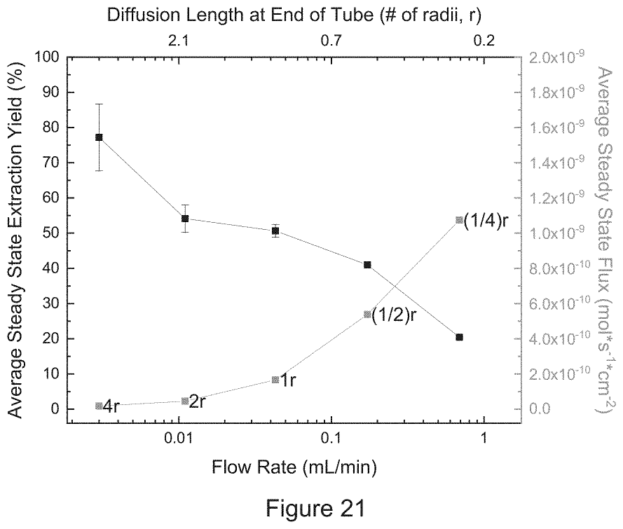

FIG. 21 illustrates average steady state extraction yield and average steady state flux at various flow rate of single fiber membrane contactor in accordance with an embodiment of the invention. FIG. 21 shows the average steady state extraction yield (left axis) and the average steady state flux (right axis) at various flow rate from lower than about 0.01 mL/min to about 1 mL/min. Porous hollow fibers such as PTFE can be used as a single fiber membrane contactor. The fiber can have about 1.0 mm inner diameter, about 250 μm thick, about 15 cm long, and a porosity of greater than about 85%. The solution includes about 2.2 mM DIC and about 100 mM NaClO₄ with a pH of about 6. About 40% of DIC exists as CO₂ (aq). More than 40% CO₂ extraction yield at slow flow rates can be due to chemical conversion of HCO³⁻ to CO₂.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A method for direct ocean capture comprising:
adding an influent solution to a container comprising at least one inlet, at least one outlet, at least one gas-liquid contactor, and at least one pump;
wherein the solution comprises at least one dissolved inorganic carbon species in a liquid phase;
wherein the at least one dissolved inorganic carbon species is converted to gas phase CO₂ when not dissolved in the solution;
wherein the solution is in contact with a first surface of the at least one gas-liquid contactor;
wherein the at least one gas-liquid contactor provides an interface for efficient species transport between the liquid phase from the at least one dissolved inorganic carbon species and to the gas phase CO₂;
collecting a gas stream from the pump, wherein the pump connects to a second surface of the at least one gas-liquid contactor, wherein the gas stream comprises the gas phase of CO₂; and
collecting the solution from the at least one outlet of the container;
wherein the at least one gas-liquid contactor separates the gas phase and the liquid phase of the at least one dissolved inorganic carbon species;
wherein the concentration of the at least one dissolved inorganic carbon in the collected solution is lower than in the added solution; and
wherein the at least one gas-liquid contactor is modified with at least one molecule and the at least one molecule increases an interconversion rate of the at least one dissolved inorganic carbon species from the solution in the liquid phase to the gas phase CO₂.

2. The method of claim 1, wherein the influent solution is selected from the group consisting of oceanwater, river water, lake water, desalinated water, an oceanwater mimic solution, and a synthetic oceanwater.

3. The method of claim 1, wherein the influent solution is titrated to a pH that is lower than the native pH of the influent solution.

4. The method of claim 1, wherein the at least one gas-liquid contactor comprises a material selected from the group consisting of polydimethylsiloxane, polypropylene, polyvinylidene fluoride, polytetrafluoroethylene, an anion exchange membrane, and a cation exchange membrane.

5. The method of claim 1, wherein the liquid phase of the at least one dissolved inorganic carbon species is selected from the group consisting of bicarbonate, carbonate, carbonic acid, aqueous carbon dioxide, and any combinations thereof.

6. The method of claim 5, wherein the at least one molecule increases an interconversion rate of bicarbonate dehydration and formation.

7. The method of claim 1, wherein the solution collected from the at least one liquid outlet has a pH value higher than the solution added to the container.

8. The method of claim 1, wherein the at least one molecule is selected from the group consisting of a buffering molecule, a decorated mixed metal oxide, an inorganic coordination compound that mimics a carbonic anhydrase enzyme, a zinc-cyclen, polymer, an amine-based polymer, polyethyleneimine, a photoacid, an excited-state reversible photoacid, a non-reversible photoacid, a metastable photoacid, a photobase, an excited-state reversible photobase, a non-reversible photobase, a metastable photobase, and any combinations thereof.

9. The method of claim 8, wherein the photoacid comprises a trisodium salt of 8-hydroxypyrene-1,3,6-trisulfonate.

10. The method of claim 1, wherein the at least one molecule is on the first surface of the at least one gas-liquid contactor.

11. The method of claim 1, further comprising acidifying the solution before extracting CO₂ from it.

12. The method of claim 1, wherein a lower flow rate of the solution being added to the container results in a higher extraction yield of CO₂ into the gas phase from the at least one dissolved inorganic carbon species in the liquid solution phase.

13. A gas-liquid contactor comprising:
a membrane; and
at least one molecule on the membrane to increase an interconversion rate of at least one dissolved inorganic carbon species in a solution from a liquid phase to a gas phase as CO₂;
wherein the membrane separates the gas phase and the liquid phase of the at least one dissolved inorganic carbon species; and
wherein the at least one molecule is selected from the group consisting of a buffering molecule, a decorated mixed metal oxide, an inorganic coordination compound that mimics a carbonic anhydrase enzyme, a zinc-cyclen, polymer, an amine-based polymer, polyethyleneimine, a photoacid, an excited-state reversible photoacid, a non-reversible photoacid, a metastable photoacid, a photobase, an excited-state reversible photobase, a non-reversible photobase, a metastable photobase, and any combinations thereof.

14. The gas-liquid contactor of claim 13, wherein the membrane is an anion exchange membrane or a cation exchange membrane.

15. The gas-liquid contactor of claim 13, wherein the membrane has a cylindrical shape and comprises a material selected from the group consisting of polydimethylsiloxane, polypropylene, polyvinylidene fluoride, polytetrafluoroethylene, polysulfone, polyethersulfone, polyether ether ketone, polyetherimide, polyethylene, and polymethylpentene.

16. The gas-liquid contactor of claim 15, wherein the membrane comprises at least one bundle of the membrane.

17. The gas-liquid contactor of claim 13, wherein the influent solution is titrated to a pH that is lower than the native pH of the influent solution.

18. The gas-liquid contactor of claim 13, wherein the liquid phase of the at least one dissolved inorganic carbon species is selected from the group consisting of bicarbonate, carbonate, carbonic acid, aqueous carbon dioxide, and any combinations thereof.

19. The gas-liquid contactor of claim 18, wherein the at least one molecule increases an interconversion rate of bicarbonate dehydration and formation.

20. The gas-liquid contactor of claim 13, wherein the at least one molecule is on one side of the membrane that is in contact with the liquid phase.
